(19) United States
(12) Patent Application Publication
(10) Pub. No.: US 2006/0140513 A1
(43) Pub. Date: Jun. 29, 2006

(54) Dynamic image production method and system

(76) Inventors: Fabrice Tran Xuan, Eybens (FR); Karine Soler, Montaud (FR); Christophe Simon, Vedene (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/533,995

(22) PCT Filed: Nov. 5, 2003
(86) PCT No.: PCT/FR03/03305

§ 371 Date: Jan. 6, 2006

(30) Foreign Application Priority Data
Nov. 6, 2002 (FR) 02/13872

(51) Int. Cl. G06F 17/00; G06K 9/54

(52) U.S. Cl. 382/305; 707/104.1

(57) ABSTRACT

A system for dynamic generation of images intended to be transmitted to at least one remote terminal, comprising a server. The server includes source images and a processor for generating from the source images of said images intended for the at least one remote terminal into a format that is compatible with the at least one remote terminal. The source images are vector images. The description file of at least one of the source images includes a description of the characteristics of the source image and at least one tag adapted to cause a manipulation of all or part of the source image. The system includes apparatus for generating a modified vector image from a source image by replacement of at least one tag by an instruction code in the description file of the source image.

The invention concerns a system and method for dynamic generation of images.

More specifically, the invention relates to a system permitting the generation of images from a source file and the downloading of said images to remote terminals for their display.

A particularly interesting application of such a method and such a system concerns the generation of images from source files extracted from computer network sites such as the Internet and the remote transmission of said images to remote terminals for viewing by the end users.

As it is known, the wide diversity of terminals used to recover such images as well as the geographical area of such computer networks, places major limitations on the final images to be displayed on the terminals.

Indeed it is necessary that the final image takes account, on the one hand, of the limitations of the remote terminals, relating in particular to their screen size, resolution, number of colours available and, on the other hand of the language in which the image must be displayed on the terminals in order to be understood by the end user.

Moreover, other types of limitations, related for example to the identity of the recipient(s), can also complicate the display of images. Thus, for example, it sometimes happens that images are all customised in the same way when they are intended for the users of the same group. This is, in particular, the case with images intended to be distributed within the subsidiaries of the same parent company for which a common formalism must be used.

In order to achieve said objectives, it has been proposed to use graphic design software used to manipulate a source image in order to export same into different graphical formats compatible with the remote terminals. As understood, such a technique is relatively unsatisfactory in so far as it requires a complete generation of the images to be displayed from the source image. It does not, moreover, take account of the problem of translating textual elements.

Other types of techniques rely on a dynamic generation of images from data received on input, by using specific image-processing programs for each type of terminal or application. Such a technique is nevertheless relatively expensive in so far as it would require a processing program for each image to be generated.

With a view to the aforementioned, the aim of the invention is to offset the disadvantages of the prior art and to provide a method and system for dynamic generation of images and transmission of said images to remote terminals permitting the automatic generation of images according to the formats corresponding to the limitations of the terminals for which they are intended and of the end users, and this completely automatically, while only requiring relatively simple and, moreover universally applicable hardware and software means, that is for all types of terminals in order to meet all of the limitations of the users.

Thus, according to the invention, a system for dynamic generation of images and transmission of said images to remote terminals is proposed, comprising a server associated to an image database and processing means for images intended for the terminals adapted to convert the images into respective formats that are compatible with the remote terminals.

The image database is a database of vector images. Moreover the processing means comprise a set of tags which are integrated into the images of the image database and adapted to cause a manipulation of the images in order to make same compatible with the remote terminals and means in order to generate images that can be read by the terminals from the manipulated images.

In order to generate an image that can be read by any type of terminal, tags are thus inserted into a file corresponding to a source image to generate a “universal” image; said tags are intended to be recognised by the processing means in order to activate the corresponding programs hosted on the server to manipulate the source image for every type of terminal.

Consequently, it is understood that only a single image processing program, which uses a plurality of image manipulation programs called for after detection of the tags, is required to generate the final image.

According to another characteristic of the invention, the images stored in the image database are images structured according to an XML grammar. The SVG format is an appropriate format for structuring the image data in the image database.

According to another characteristic of the system according to the invention, the processing means comprise moreover a set of image processing programs selectively activated by said tags to modify as a result an image extracted from the image database.

Said processing means include moreover the means for generating a suitable stylesheet in order to insert presentation data into the images.

According to an example of embodiment, said stylesheets consist of XSLT type transformation means.

The generation means of the stylesheet comprise, for example, means for generating the stylesheet according to data transmitted from remote terminals.

According to a working example, the means for generating readable images are hosted in the server.

Alternatively, if the terminals allow it, the means for generating readable images are hosted in the terminals.

According to another characteristic of the invention, the server comprises in addition a cache memory for the storage of images generated by the processing means.

Furthermore, it may be noted that said processing programs comprise means for causing insertion of instruction codes into the image extracted from the database according to at least one tag argument.

Preferably, the tag arguments are conveyed by requests transmitted by the remote terminals.

According to the invention, a method for the dynamic generation of images and their transmission toward the remote terminals is also proposed. Said method is characterised in that it includes steps comprising:

storing vector images in an image database managed by a server, each of the images including each suitable tags to cause a manipulation of the images to make same compatible with the remote terminals for the display of the images;

modifying the images according to the inserted tags; and

generating images that can be read by the terminals from the images in which the tags are inserted.

During the image modification step, the processing program causes the generation of a programming code and the dynamic enrichment of an image file by the insertion of said code in replacement of the tags.

According to a working mode, the images that can be read by the terminals are generated by said terminals.

Alternatively, the images that can be read by the terminals are generated by the server.

Other aims, characteristics and advantages of the invention will appear in the following description, provided by way of non limitative examples, and made in reference to the appended diagrams of which:

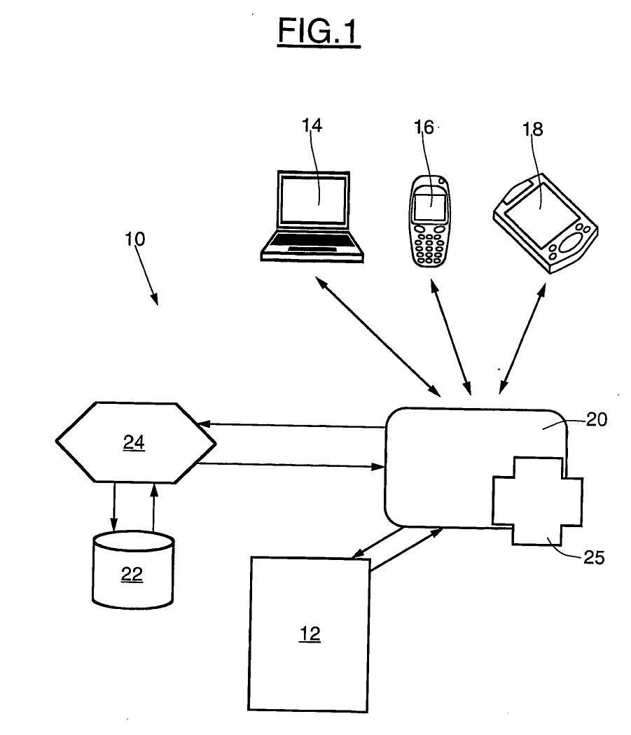

FIG. 1 is a schematic view of a system for the generation and transmission of images in accordance with the invention; and

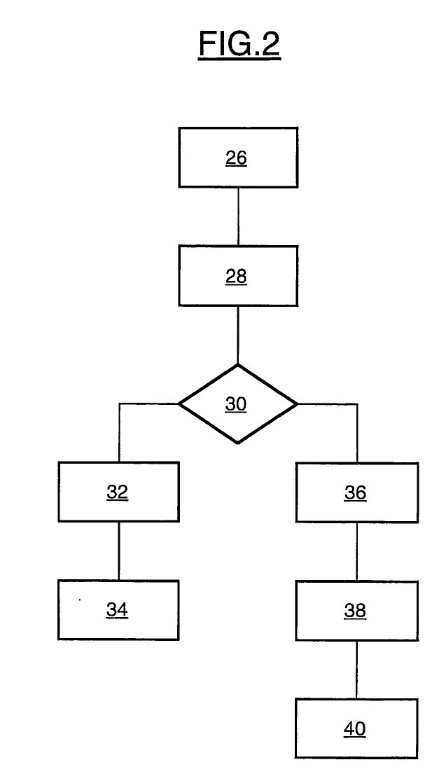

FIG. 2 is a flow chart illustrating the main phases of a process implemented using the system from FIG. 1.

In FIG. 1, the general structure of a dynamic system for the generation and transmission of images in accordance with the invention is represented, designated by the general digital reference 10.

It is intended to extract images from an image database 12 in response to requests formulated by remote terminals such as 14, 16 and 18, and to process said images in order to make same compatible with the limitations of each terminal, particularly in terms of resolution, number of colours available, size of screen, while at the same time conserving the quality of an initial image, but also by taking account of other types of limitations, such as linguistic limitations, by carrying out the dynamical translation of the textual elements contained in an image so as to make same understood by the remote user, and limitations related to the predetermined formalisms imposed by the user issuing the request.

As shown in FIG. 1, the remote terminals likely in principle to receive the images may be comprised of computer terminals of different types. They may in effect be comprised of micro-computers, mobile telephones and persona digital assistants, etc.

Each of said pieces of equipment presents characteristics and capabilities which lead to specific constraints for the display of images.

Thus, in response to the requests formulated by a user, the system 10 causes a dynamic manipulation of the images extracted from the image database 12 so as to meet all of the limitations related to the terminal and to user concerned.

To this effect, the system 10 essentially consists of a server, comprised of, for example, a server hosting an internet site.

As shown in FIG. 1, the server comprises, moreover the image database 12, a processing stage 20 assuring recovery of the images loaded in the image database 12 in order to transform same into images presented in a format likely to be displayed on terminals 14, 16 and 18.

Said processing stage is connected to a cache memory 22, via a management stage 24 for the storage of the images generated by the processing stage 20.

As regards the image database 12, this gathers together all of the images likely to be consulted by the users. Said images are loaded in files structured according to an XML grammar (“eXtensible Markup Language”, in English).

More specifically, the files stored in the image database 12 are structured according to the format known as SVG (“Scalable Vector Graphics”, in English) that is in the form of vector images. Such a format permits the storage of images in a form more compact than a pixel-by-pixel description, as would be done according to the GIF, JPEG, PNG, etc. formats.

Moreover, such an image storage format makes the description of an image in terms of objects possible and authorises manipulation of the images by working on the elements of which it is composed, in contrast to image formats according to which the images are described pixel by pixel.

The files stored in the image database 12 are generated from source files regrouping, in vector form, that is, according to the SVG format, all of the available images.

As already known, an SVG file is an XML language application. It is presented in the form of a text file the editing of which is possible using a text editor, which permits modifications to be carried out without launching an image editor.

Such a SVG file is described using XML tags each one serving as the description of a characteristic of an image.

In accordance with the invention, from original source files, additional tags are inserted by means of, for example, a conventional text editor. Said tags being used to launch the execution of programs by the processing stage 20 so as to cause a modification of the images making same compatible with a terminal on which they have to be displayed.

Thus, as understood, the images stored in the image database 12 are comprised of universal files, that is, files common to all of the available terminals.

The tags that may be used to enrich the source image files may be of different types, according to the image manipulations to be carried out.

It may be noted, in particular, that the translation tags, in order to cause an on-the-fly translation of the textual elements according to the language used by the user may be inserted into the source files.

Likewise, image texture modification tags may be planned. Such tags permit the customisation of all or part of the SVG content by acting on factors such as fill, background, layout, font, etc. colours, font size and fonts, etc.

Finally, image manipulation tags may be planned. For example, such tags may be used to either isolate part of an image, for example to display part of a geographical map on a mobile telephone handset or personal data assistant the screen size of which does not allow the display of such a map in an acceptable scale, or to execute geometric functions such as translations, rotations, scalings, etc., or even zoom functions (positive or negative, on all or part of the image).

From said images, the server and in particular the processing stage 20, generates the modified images by enriching the initial content of the images through the dynamic insertion of content.

In particular, the processing stage 20 recovers the argument values conveyed in the requests transmitted by the terminal 14, 16, 18, inserts respectively said arguments into the corresponding tag attributes, then carries out the execution of the programs, according to the tags contained in the image files and according to the arguments recovered from the requests, in order to generate the instruction codes. Said instruction codes are then inserted into the files instead of and in replacement of the tags.

A SVG file is then created, at this stage, specific to each terminal and responding to all of the limitations imposed by the display.

A processing module 25, integrated into the processing stage 20, is then used to convert the enriched SVG file into images likely to be read by the terminals 14, 16 and 18, for example, images in GIF, JPEG, PNG TIF, etc. format.

The images thus generated are then stored in the cache memory 22 in order to be later available for downloading again to users in response to similar requests.

The general structure of the files loaded in the image database 12 will now be described. In particular, some examples of tags that can be used to cause a modification of images through code enrichment will be described hereinafter.

In what follows, the tags used for the image descriptions are comprised of conventional type elements familiar to a person skilled in the art and have not been described again.

As previously indicated, a SVG file is a document structured in accordance with an XML grammar and must therefore start with a header specifying the XML version used.

All of the SVG file elements are then described using the tags. Tags recognised by the SVG language must be defined in a DTD (“Document type Definition”) file. Thus the XML files stored on the image database 12 must, before anything else, begin with a reference to said DTD document.

During the generation of the image database 12, extra tags used in said document are also inserted.

As regards the tags that may be integrated into the source file, the following tags may be used:

“Background Color”: said tag permits the addition of a background colour to a SVG image. Said tag is based on a “color” parameter value (chosen background colour), stored in an HTTP request transmitted by the terminals. Thus, for example, the code used to insert said tag into the source file will be of the form:

<svg...>

< svg : background color/>

</svg>

“Black White”: said tag defines an image section in which colour management is involved. It permits the application of a black and white filter on a vector image or on an existing image of type GIFF, JPEG, etc. It is based on the parameter value that indicates if a black and white filter must be indicated or not of Boolean type, stored in an HTTP request. Thus, for example, the code used to insert said tag into the source file will be of the form:

<svg...>
<defs> ...</defs>

< svg : black white>
< /svg : black white>

</svg>

“Canevas”: said tag relies on a concept of “virtual display surface”. It permits the defining of a surface used as a calculation base to generate the size of objects contained in said surface. It is based on the WIDTH and HEIGHT parameter values stored in an HTTP request and on the WIDTH and HEIGHT attributes in order to calculate a re-dimensioning ratio. Thus, for example, the code used to insert said tag into the source file will be of the form:

<svg : canevas width= [symbol] 150 [symbol] height= [symbol] 100 [symbol] >
<svg width= [symbol] 150 [symbol] height= [symbol] 100 [symbol] viewbox= [symbol] 0 0 150 100 [symbol] ...>
</svg>
</svg : canevas>

“Clipping”: said tag permits a region in a SVG image to be selected. A selection rectangle permits said region to be delimited. Said tag relies on the X and Y parameter values corresponding to the X and Y coordinates of a point located in a top left-hand corner of the rectangle, and of a parameter WIDTH and HEIGHT (width and height of the selection rectangle), stored in an HTTP request. Thus, for example, the code used to insert said tag into the source file will be of the form:

<svg...<svg :clipping/>...>
</svg...>

“Encoder”: said tag defines a section where the user will configure a transcoder. Said tag uses the URL address of the transcoder to be used and must itself be integrated to another tag. Thus, for example, the code used to insert said tag into the source file will be of the form:

<svg : encoder name= [symbol] svg [symbol] url= [symbol] http://xxxxxx.jsp [symbol] >
</svg : encoder>

Encoder_Parameter: said tag permits the addition of a parameter that will be transmitted to the source to be transcoded. Thus, where a data flow to be transcoded arises from the execution of an element from the JAVA program, the latter can be configured at will. For example, the code used to insert said tag into the source file will be of the form:

<svg>
<svg : encoder unit url = [symbol] http://xxxx/transcoder/transcoder [symbol] >

<svg : encoder name= [symbol] svg [symbol] url= [symbol] http://xxxxxx.jsp [symbol] >

<svg : encoder parameter name= [symbol] width [symbol] value = [symbol] 100 [symbol]
<svg : encoder parameter name= [symbol] height [symbol] value = [symbol] 100 [symbol]
<svg : encoder parameter name= [symbol] mime [symbol] value = [symbol]
image/png

[symbol]

</svg :encoder>

</svg :encoder unit>
</svg>

Encoder-Unit: said tag defines a section involving the use of a transcoder. We can refer to the abovementioned example to obtain a description of such a tag

Rescale-Height: said tag permits the calculation of the height of an object contained in a form, from its initial height, corresponding to a tag attribute. Thus, for example, the code used to insert said tag into the source file will be of the form:

<svg...height= [symbol] svg : rescale height value [symbol] 100 [symbol] / >

viewbox = [symbol] 0 0 150 100 [symbol] ...>

</svg>

Rescale-Width: said tag permits the calculation of the width of an object contained in a form from its initial width, corresponding to a tag attribute. Thus, for example, the code used to insert said tag into the source file will be of the form:

<svg...width= [symbol] svg : rescale width value = [symbol] 150 [symbol] / >...

viewbox = [symbol] 0 0 150 100 [symbol] ...>

</svg>

“Rotation”: said tag defines a section of an image involving a rotation of the image. It relies on the values of the “Angle” (rotation angle) X and Y (coordinates of a point of rotation) parameter, stored in an HTTP request. For example, the code used to insert said tag into the source file will be of the form:

<svg...>

<defs> ...</defs>
<svg :rotation>
</svg :rotation>

</svg...>

“Translation”: said tag defines a section involving the geographical translation of the image. It relies on the TX and TY (translation according to the directions X and Y) parameter values, conveyed by an HTTP request. For example, the code used to insert said tag into the source file will be of the form:

<svg...>

<defs> ...</defs>
<svg :translation>
</svg :translation>

</svg...>

“Zoom”: said tag permits the zooming in on a region of a SVG image by indicating a zoom level. Said tag relies on the X and Y parameter values, which correspond to the X and Y coordinates of a point, in the original image, from which the zoom will be carried out, the WIDTH and HEIGHT parameter values, which correspond to the width and height of the destination image resulting from the zoom, and a zoom parameter, which are stored in the HTTP request coming from the terminals. Said tag must itself be contained in a <<Canevas>> tag. For example, the code used to insert said tag into the source file will be of the form:

<svg : canevas width= [symbol] 800 [symbol] height= [symbol] 600 [symbol] >
<svg...< svg:zoom />...>
</svg>
</svg :canevas>

“Zoom_Auto”: said tag permits zooming in on a region of an SVG image in two ways:

either by indicating a selection rectangle in the original image, defined from a point of the X1, Y1 coordinates, which corresponds to a top left-hand corner of the rectangle, using width and height; said rectangle represents the region in which the zoom will be carried out, the width and height of the destination image representing the result of the zoom;

or by indicating a selection rectangle in the original image, defined using two points of the X1, Y1 and X2 and Y2 coordinates: said rectangle representing the region in which the zoom will be carried out, from an optional horizontal and vertical edge, added to the size of the rectangle, the width and height of the destination image representing the result of the zoom.

Said tag must itself be contained in a <<Canevas>> tag. For example, the code used to insert said tag into the source file will be of the form:

<svg : canevas width= [symbol] 800 [symbol] height= [symbol] 600 [symbol] >
</svg...< svg:zoom_auto />...>
</svg>
</svg :canevas>

<<decode>>: said tag permits decoding of the text contained in its body. It may be noted that said tag does not use any argument but analyses the text contained in its body.

<<encode>>: said tag permits coding of the text contained in its body. It may be noted that said tag does not use any argument but analyses the text contained in its body.

<<translation_unit>>: said tag defines a section in which a translation of the text will be carried out. It uses a constant named <<SecuredvalkyrieConstants.language_request_param>> which defines the current language selected by the user. For a description of said tag, the tag example below will be referred to.

<<Translate>>: said tag permits the translation of a text contained in its tag body. For example, the code of said tag is as follows:

<translation_unit source= [symbol] mail/xsl/inbox [symbol] >
<b><translate text= [symbol] WELCOME [symbol] /></b>
<i><translate text= [symbol] CONTINUE [symbol] /> ?</i>
<i>
<translate text= [symbol] YES [symbol] />
<translate text= [symbol] NO [symbol] />
</i>
</translation_unit>

As previously indicated, said tags, which use attributes or data conveyed by the HTTP requests transmitted from the terminals 14, 16 and 18, cause the generation of SVG codes and the replacement of said tags by the code generated. Of course, other tags can be used according to the limitations to be overcome or the objectives to be achieved.

It may be noted that, because of the format used, the code generation means may be made by text editors which are cheaper as regard programming means than image editors.

With reference to FIG. 2, the main steps in a method for the dynamic generation and transmission of images will now be described, in accordance with the invention.

Firstly, during a first step 26 images for the image database 12 are generated from an original file, through the insertion of tags.

As soon as a request is received by the server (step 28) relating to the recovery of an image, the processing stage 20 queries the management stage 24 of the cache memory to see if such an image has already been generated (step 30).

If this is the case, the management stage 24 extracts the image from the cache memory 22 and transmits it to the processing stage 20 (step 32), which retransmits it directly to the terminal having made the request (step 34).

If this is not the case, that is if no corresponding image is stored in the cache memory 22, during the following step 36, the processing stage 20 recovers an image from the image database 22 and recovers the attributes or the data elements conveyed by the HTTP request transmitted by terminal 14, 16 or 18. As previously indicated, said image is presented in the form of an SVG file, described using XML tags and comprising moreover additional tags making it universal, that is, suitable in principle to any type of support, subject to a manipulation.

During the following step 38, the processing stage recovers the programs corresponding to the additional tags introduced into the recovered image file and then launches the execution of said programs according to the attributes transmitted by the request to generate additional SVG code. The code is then inserted into the image instead of and in replacement of the tags concerned.

From said SVG code, the processing stage 20 implements the processing module 25 in order to generate an image likely to be directly displayed on the screen of the terminal concerned, for example in GIF, JIPEG, TIFF, etc. format.

During the following step 40, the processing stage 20 transmits the image thus generated to the terminal and to the management stage 24 to be saved in the cache memory 22. The image may thus be recovered later, upon request.

It can be noted, where the terminal 14 is comprised of a micro-computer which has a display screen compatible with the SVG format, the processing module 25 is not implemented, the SVG code being directly transmitted to the terminal.

Likewise, the processing carried out by the processing module 25, may, where appropriate, be directly carried out within the terminals, where their capacity allows it.

Finally, it can be noted that the documents present in XML format generally separate the image background and form and do not convey any display data. Thus, preferably, the processing stage 20 incorporates XSLT (“Extensible Style Sheet Language Transformation”) type processing means so as to apply a stylesheet to the images in order to complete same by inserting display data.

For example, the stylesheet used is a stylesheet in JAVA programming language or a JSP (“Java Server Page”) stylesheet so as to introduce an upstream data display insertion mechanism, that is prior to the generation of images in GIFF, JIPEG, PNG, TIFF, etc. format, that can be directly displayed on the screens of terminals 14, 16 and 18.

Finally, preferably, a single stylesheet is planned for all of the terminals. Said stylesheet is dynamically manipulated by the processing stage 20 according to the data transmitted from each remote terminal. Said stylesheet is then automatically adapted to the limitations of each terminal, which permits an improvement in the power of the process and a reduction in its running cost.

1-17. (canceled)

18. A system for dynamic generation of images intended to be transmitted to at least one remote terminal, comprising a server comprising source images and processing means for the generation from said source images of said images intended for said at least one remote terminal into a format that is compatible with said at least one remote terminal,
wherein said source images are vector images, the description file of at least one of said source images comprising a description of the characteristics of said source image and at least one tag adapted to cause a manipulation of all or part of said source image, and
wherein said system comprises means for generating a modified vector image from a source image by replacement of at least one tag by an instruction code in said description file of said source image.

19. A system according to claim 18, wherein said modified image is generated in response to a request sent from said at least one remote terminal, said instruction code being generated according to data conveyed by said request.

20. A system according to claim 18, wherein said system further comprises means for converting said modified vector image into a pixel image.

21. A system according to claim 20, wherein said means for converting said modified vector image into a pixel image are hosted in the server.

22. A system according to claim 20, wherein said means for converting said modified vector image into a pixel image are hosted by said remote terminal.

23. A system according to claim 18, wherein said processing means comprise a set of image processing programs selectively activated by said tags in order to modify as a result a source image.

24. A system according to claim 18, wherein said processing means further comprise means for generating a stylesheet adapted to insert presentation data into the images.

25. A system according to claim 24, wherein said means for generating said stylesheet comprise means for generating said stylesheet according to data transmitted from the remote terminals.

26. A method for dynamic generation of images intended to be transmitted to at least one remote terminal,
wherein said images are generated from source vector images, the description file of at least one of said source vector images comprising a description of the features of said source vector image and at least one tag adapted to cause a manipulation of all or part of said source vector image, and
said method including a step consisting of generating a modified vector image from a source vector image by replacement of at least one tag by an instruction code in said description file of said source vector image.

27. A method according to claim 26, wherein said method further includes a step consisting of converting said modified vector image into a pixel image.
